(19) United States
(12) Patent Application Publication
(10) Pub. No.: US 2015/0242580 A1
(43) Pub. Date: Aug. 27, 2015

(54) SYSTEMS AND METHODS FOR POINT OF CARE GUIDANCE

(71) Applicant: MedicalCue, Inc., Mountain View, CA (US)

(72) Inventors: Peter DAVID, San Jose, CA (US); Peter COELHO, Hollister, CA (US)

(73) Assignee: MedicalCue, Inc.

(21) Appl. No.: 14/630,802

(22) Filed: Feb. 25, 2015

Related U.S. Application Data
(60) Provisional application No. 62/083,664, filed on Nov. 24, 2014.
(60) Provisional application No. 61/944,985, filed on Feb. 26, 2014.

(51) Int. Cl. G06F 19/00; G06F 17/30

(52) U.S. Cl. CPC G06F 19/345; G06F 17/30424

(57) ABSTRACT

The present disclosure describes a point of care guidance system that can be used by health care professionals to diagnose clinical states and perform critical and non-critical medical procedures. The system can use medical algorithms, patient specific data, and electronic medical records to develop optimized, patient-specific operating procedures and generalized standard operating procedures. A system or user of the system can also input physiological, positional, or geographic parameters into a system of the invention to create customized standard operating procedures.

### CROSS REFERENCE

This Application claims the benefit of United States Provisional Application No. 61/944,985, filed Feb. 26, 2014, and United States Provisional Application No. 62/083,664, filed Nov. 24, 2014, each of which is incorporated herein by reference in its entirety.

### BACKGROUND

Physicians and health care professionals are often expected to memorize and recall medical algorithms that involve a multitude of steps and treatment protocols, and to implement the algorithms during times of crisis and high pressure. Individuals can be limited in both input and output processing of multiple, simultaneous stimuli, and limitations in the processing of many stimuli can lead to crucial delays in understanding and action during high-intensity activities. Existing medical care algorithms can be rigid and not flexible to unique patient circumstances, thus presenting challenges and uncertainty in implementation. Easily-accessible, customizable, and user-friendly systems of medical algorithms can increase the effectiveness of medical care, especially in critical situations.

### SUMMARY OF THE INVENTION

In some embodiments, the invention comprises a method of providing a healthcare protocol, the method comprising: a) receiving by a computer system a parameter of a subject; b) searching by a processor of the computer system based on the parameter of the subject in a database, wherein each entry in the database independently comprises: i) a healthcare protocol; and ii) an indication of a likelihood of obtaining a favorable outcome upon application of the healthcare protocol to the subject as determined by a statistical analysis of the healthcare protocol based on prior clinical use of the healthcare protocol; c) identifying the healthcare protocol in the database based on the search of the database; and d) outputting the identified healthcare protocol.

In some embodiments, the invention provides a method of accessing a healthcare protocol, the method comprising: a) accessing by a user a computer system, wherein the computer system comprises a database, wherein each entry in the database independently comprises: i) a healthcare protocol; and ii) an indication of a likelihood of obtaining a favorable clinical outcome upon application of the healthcare protocol to a subject as determined by a statistical analysis of the healthcare protocol based on prior clinical use of the healthcare protocol; b) inputting by the user or system a parameter of the subject into the computer system; c) searching the database by a processor of the computer system based on the parameter of the subject; and d) identifying the healthcare protocol in the database based on the search of the database.

### BRIEF DESCRIPTION OF THE FIGURES

FIG. 1 displays an illustrative user interface of the system.

FIG. 2 depicts results of percent adherence of PPV from Scenario A of an application of the system.

FIG. 3 depicts results of percent adherence of PPV from Scenario B of an application of the system.

FIG. 4 depicts results of percent adherence of PPV from Scenario C of an application of the system.

FIG. 5 depicts results of percent adherence of CC from Scenario A of an application of the system.

FIG. 6 depicts results of percent adherence of CC from Scenario B of an application of the system.

FIG. 7 depicts results of percent adherence of CC from Scenario C of an application of the system.

FIG. 8 depicts results of percent adherence to FiO₂ adjustments for scenarios A, B, and C.

FIG. 9 is an illustrative user interface for initializing subject care.

FIG. 10 is an illustrative user interface for activation of a neonatal care path.

FIG. 11 is an illustrative user interface for resuscitation care.

FIG. 12 an illustrative user interface to monitor breathing status of a subject.

FIG. 13 is an illustrative user interface for assessment of breathing and heart rate.

FIG. 14 is an illustrative user interface for prompting of PPV.

FIG. 15 is an illustrative user interface for activation of PPV.

FIG. 16 is an illustrative user interface for prompting of chest compressions.

FIG. 17 is an illustrative user interface for activation of PPV and chest compressions.

FIG. 18 is an illustrative user interface for prompting of epinephrine.

FIG. 19 is an illustrative user interface for prompting of CPAP.

FIG. 20 is an illustrative user interface for activation of PPV, activation of compressions, and discontinuation of compression.

FIG. 21 is an illustrative user interface for prompting of CPAP and discontinuation of PPV and compressions.

FIG. 22 is a block diagram illustrating a first example architecture of a computer system that can be used in connection with example embodiments of the present invention.

FIG. 23 is a diagram illustrating a computer network that can be used in connection with example embodiments of the present invention.

FIG. 24 is a block diagram illustrating a second example architecture of a computer system that can be used in connection with example embodiments of the present invention.

FIG. 25 illustrates a global network that can transmit a product of the invention.

### DETAILED DESCRIPTION

### Methods of a System of the Invention.

A system that assists a health care professional can lead to favorable outcomes for patients and reduce the memorization, recall and implementation burden of health care professionals. A system described herein can assist a health care professional in determining and implementing a custom or standard operating procedure for a subject based on existing medical algorithms and past data on a condition. The system can further perform statistical analysis on various indications and assess whether a prescribed procedure is the optimal course of action for the subject.

A system of the invention can act as a decision guidance and tracking tool to provide a user with support and cues during performance of a medical procedure. The system can be used during times of emergency, when a user's judgment and decision-making abilities can be impaired due to the surrounding stress and urgency of the situation. The system can also be used during routine medical procedures to, for example, explore alternative diagnoses or more efficient methods of treatment.

A system of the invention can comprise a database of medical diagnoses, physiologic norms and care algorithms. A system of the invention can further comprise a database of medical care algorithms that can be customized based on the current condition of the subject, and previous methods that have been used successfully to diagnose and treat similar conditions. A system or user of the invention can input various characteristics of the subject including, for example, genetic profile, medical history, family medical history, diagnostic study data, vital signs, behavior, height, weight, gender, age, prior/current medical interventions and dosages of prior/current medications being used to treat the subject, and the system can use the information to identify a standard clinical protocol or develop a custom clinical protocol for the subject.

A system of the invention can comprise a database of facility and provider specific training, testing and performance data, personal health data, maternal health data, maternal and patient prenatal monitoring and electronic medical records (EMR). EMRs can comprise clinical information, for example, medical history, family medical history, medications, allergies, immunization status, laboratory test results, radiology images, vital signs, age, weight, height, blood pressure, lifestyle, genomic data, injuries, discharge notes, admission notes, and billing information. The medical records can serve as case histories within which the system can search to determine appropriate standard operating procedures based on the current condition of the subject. The system can assess the condition of a subject, and use the condition to find corresponding EMRs of subjects who had, or have, the same, or a similar condition. The EMRs used in a system of the invention can comprise a specific ontological database for clinical data. The use of ontology for clinical data can facilitate the streamlining of data across institutions and healthcare professionals. Non-limiting examples of ontologies that can be used by a system of the invention include SNOMED, Anatomical Entity Ontology, BioAssay Ontology, Clinical Measurement Ontology, Diagnostic Ontology, Family Health History Ontology, Gene Ontology, Gene Regulation Ontology, Human Disease Ontology, Open Biomedical Ontologies, Open Biological and Biomedical Ontologies, Ontology for Biomedical Investigations, SNOMED Clinical Terms, and Symptom Ontology.

Assessing a subject's condition can occur via input of information by the user or by data gathered by components of the system. The system can perform comparisons between similar case histories and determine which interventions were effective and led to positive outcomes. Based on the comparison, the system can recommend an appropriate standard or customized operating procedure for the user to implement when treating the subject.

A system of the invention can improve clinician performance during clinical events. The user interface can be designed to display data required to implement well-established medical algorithms continuously, and provide a combination of auditory and visual prompts. The software used in a system of the invention can use a practitioner's performance data and a patient's clinical data, in real-time, to prompt users in discrete time intervals to deliver specific interventions based upon medical algorithms.

A system of the invention can increase the likelihood that a user will make a better decision regarding a patient's condition. The percent likelihood that a user will make a better decision can be, for example, about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 60%, about 70%, about 80%, about 90%, or about 100%.

A system of the invention can increase the likelihood that a user will perform a better intervention regarding a patient's condition, e.g. chest compressions and positive pressure ventilations. The percent likelihood that a user will perform better, more consistent technique or more consistent time of intervention can be, for example, about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 60%, about 70%, about 80%, about 90%, or about 100%.

A system of the invention can also detect vital signs and physiological parameters of a patient using, for example, a sensor. Non-limiting examples of physiological information sensors of the system can ascertain include: heart rate and pattern, breathing rate, breathing volume, oxygen saturation, blood perfusion, and patterns, movement, vocalization, blood pressure and weight. The sensor can be placed, for example, in proximity to, or in direct contact with, the subject. The sensor can be placed on the skin or umbilical cord of the subject. The sensor can be placed in the bed, sheets, pillow or medical equipment of the subject. The sensor may also be non-contact, such as a microphone, or a video camera, or a device to measure temperature or distances. Clinical data that can be monitored using a sensor of the system include, for example, heart rate and pattern, blood perfusion, and pattern, respiration effort, rate, volume and flow-rate patterns, weight, blood pressure, respiratory gases such as: FiO₂ (fraction of inspired oxygen), SpO₂ (oxygen saturation), SpCO₂, CO₂, body temperature, pH, pulse oximetry, and blood glucose.

A user of the system can include, for example, a health care professional. Non-limiting examples of a health care professional include a paramedic, an emergency medical technician, a fireman, a first responder, a physician, a nurse, a nurse practitioner, a physician's assistant, a technical clinician, respiratory therapist, a surgeon, an anesthesiologist, an oncologist, a radiologist, a dermatologist, a midwife, an obstetrician, a neonatologist, a pediatrician, a dentist, an orthodontist, a pharmacist, a psychiatrist, and a veterinarian.

A subject can be, for example, an elderly adult, an adult, an adolescent, a pre-adolescent, a child, a toddler, an infant, and a neonate. A subject can be, for example, in need of critical care, semi-critical care, non-critical care, routine care, emergency care, surgery, or preoperative assessment. A subject can be a patient.

A system of the invention can be used when a subject has a medical condition needing observation or treatment. Critical and emergency conditions that can be assessed by a system of the invention include but are not limited to, for example, surgical patients, change in health status during diagnostic or treatment procedures, falls, syncope, hypotension, respiratory difficulty, anaphylaxis, angina, appendicitis, severe burns, cardiac arrest, childbirth, dehydration, diabetic coma, drug overdose, adverse drug reaction, hyperthermia, hypothermia, infection, insulin shock, internal bleeding, multiple organ failure, myocardial infarction, premature birth, maternal labor, pulmonary embolism, renal failure, respiratory arrest, respiratory distress, seizures, sepsis, severe allergic reaction, severe gastrointestinal distress, shock, stroke, subdural hematoma, syncope, trauma, traumatic brain injury, and ventricular tachycardia.

A system of the invention can also be used for routine medical procedures in the inpatient and outpatient settings. Routine medical procedures that can be addressed by a system of the invention include, for example, allergy skin testing, blood product testing, blood product administration, biologic medicinal product administration, bone density scans, breast biopsies, gastrostomy tube placements, colonoscopies, esophagogastroduodenoscopies, CT scans, MRI scans, dental procedures, electrocardiograms, cardiac and pulmonary testing and imaging, endotracheal and nasotracheal intubation, laryngoscopy, lumbar puncture, epidural and spinal anesthesia, paracentesis, thoracentesis, cardiocentesis, anesthetic and surgical preparatory procedures, outpatient infusion and transfusion services, cardiac and pulmonary stress testing, eye exams, general medical exams, gynecological exams and procedures, immunizations, infusions and injections, mammograms, pap smears, physical therapy, prostate biopsies, cystoscopies, bone marrow biopsies, tonsillectomy, ultrasounds, tuberculosis testing, radiologic imaging, and outpatient procedures.

In some embodiments, the system can be used for neonatal care. A system of the invention can provide three or more care paths for neonatal care including, for example, observation care, resuscitation care, and routine care. The care paths provided by the system can be chosen based on, for example, inputted historical data for the neonate or mother, time from birth of the neonate, user assessment input, and physiological data.

A system of the invention can be used in response to an environmental event or crisis in or outside of a work environment, such as a clinic, hospital, or other health care facility. For example, guidance for specific evacuation or procedural protocols for fire, hazardous material spill, flood, tornado, earthquake, shooter, act of terrorism, threatening individual, and abduction.

A system of the invention can be used in response to an immediate need for documentation of a medical event, medical error event, Never Event, sentinel event, medical personnel exception event, medication error event, medical treatment error event, work space environmental safety event, inventory supply status, or exception.

In some embodiments, the invention provides a method of a providing a crisis protocol, the method comprising: a) receiving by a computer system a parameter of a subject; b) searching by a processor of the computer system based on the parameter of the subject in a database, wherein each entry in the database independently comprises: i) a crisis protocol; and ii) an indication of a likelihood of obtaining a favorable outcome upon application of the crisis protocol to the subject as determined by a statistical analysis of the crisis protocol based on prior clinical use of the crisis protocol; c) identifying the crisis protocol in the database based on the search of the database; and d) outputting the identified crisis protocol.

Annual and semi-annual training can be given regarding the system to ensure all users are familiar with updates and new features of the system as they become available. Users can also be scored as to their adherence to the care protocols of the system, be given feedback by raters and have customized training tailored to their strengths and weakness.

A system of the invention can be displayed to a user by a graphical interface. The system can be a software application that can be installed on, for example, a computer, a laptop, a tablet, optical device, auditory device or a mobile device.

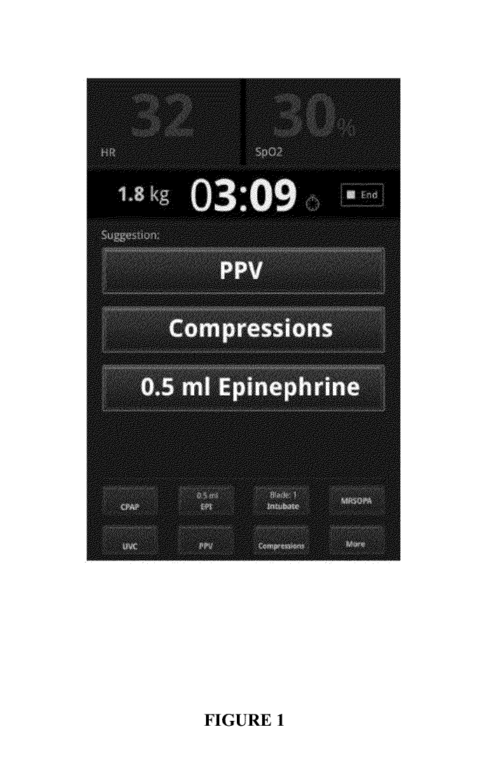

FIG. 1 depicts an illustrative example of a user interface of the system for neonatal care. At the top of the interface, the system can display the current heart rate (HR) and SpO₂ of a subject. The system can also display to the user the mass of the subject, surface area, standard tool sizes, standard medication dosages and the elapsed time since the procedure has been activated. The system can also provide the user an option of ending the procedure by the touching the “End” box. The system can then provide suggestions to the user based on the current conditions of the subject. For example, the system can suggest that the subject be given positive pressure ventilation (PPV), chest compressions, and 0.5 mL of epinephrine. These suggestions can arise from the prior input of patient status, prior therapies, with reference to standards of care. These suggestions can arise from probabilistic or neural network analysis of the same inputs. At the bottom of the interface are icons the user can select to obtain more options for treating the patient. The user can select continuous positive airway pressure (CPAP), specific doses of epinephrine (0.5 mL EPI), whether or not to intubate the subject (Blade: 1; Intubate), whether or not the subject needs an umbilical vein catheter (UVC), chest compressions, PPV, and MRSOPA. MRSOPA is an acronym for the maneuvers that can be performed during neonatal resuscitation if there is ineffective ventilation by the neonate. The “M” reminds the healthcare professional to ensure that the breathing mask is tightly applied to the face of the subject. The “R” stands for repositioning the head of the subject in the proper orientation. The “S” stands for suctioning the nares and the pharynx. The “O” stands for opening the mouth of the subject. The “P” stands for increasing the pressure of PPV to a pre-defined maximum. The “A” stands for making arrangements for an alternate airway if these procedures are not effective.

### Databases Used in a System of the Invention.

The data used to perform the statistical analysis and build standard operating procedures can be sourced from a variety of databases. The data can be, for example, personal health data, in-house data, national data, network data, hospital data, and academic institution data. The data can be sourced from, for example, personal sensors, community data pools, electronic health records, electronic medical records, pharmacy medical records, and insurance claim reports.

The system can create one, or more, standard operating procedures. These standard operating procedures can be generic for types of patients, e.g. neonates, or can be patient specific. Once the statistical analysis has determined a set of appropriate standard operating procedures, the system can rank the standard operating procedures based on a statistical confidence level as calculated by the system. The confidence level can be based on, for example, success of the procedure in the past, preference toward the procedure by healthcare professionals, the experience of the healthcare professionals, and the short or long term patient response to the procedure in the past.

The database of standard operating procedures can be organized by, for example, type of a procedure, age of a subject, gender of a subject, condition of a subject, gravity of the condition of a subject, diseases, interventions, routine procedures, emergency procedures, healthcare institutions, and healthcare professionals. The database can be searched by inputting physiological parameters of a subject, whereby the system can then access the database to determine the condition of the subject, and recommend a standard operating procedure for treatment of the condition. If the user knows for which condition a standard operating procedure is required, then the user can select a subset of procedures specific for that condition. The database can also be computationally analyzed autonomously, for example, by the application of neural networks, or support vector machines, or by multidimensional Bayesian analysis.

The results of the search can be provided as prompts and suggestions with a multi-modal graphical user interface. The user can then scroll through the available standard operating procedures to determine the most appropriate procedure for the present condition of the subject. The procedures that are not chosen by the user can be visible as icons on the interface for the user to choose later, if desired.

### Statistical Analysis Used in a System of the Invention.

The system can capture actions of the users and do large sample, large statistical analytics to determine statistically-significant improvements to care. The system can assign a prior probability to a current treatment method for a specific condition, update the method, and assign a posterior probability to the new treatment method as suggested by the system. The analytics engine of the system can further identify case histories and EMRs that can be significant for choosing among procedures. A large population size can allow the system to determine standard operating procedures whose statistical confidence exceeds the potential expected population, and allow health care professionals to use the standard operating procedure knowing that the procedure is reliable to a certain number of standard deviations above the mean.

The number of records used for statistical analysis performed by the system can be, for example, about 10, about 20, about 30, about 40, about 50, about 100, about 200, about 300, about 400, about 500, about 1000, about 1500, about 2000, about 2500, about 3000, about 3500, about 4000, about 4500, about 5000, about 10,000, about 11,000, about 12,000, about 13,000, about 14,000, about 15,000, about 16,000, about 17,000, about 18,000, about 19,000, about 20,000, about 25,000, about 30,000, about 35,000, about 40,000, about 45,000, about 50,000, about 60,000, about 70,000, about 80,000, about 90,000, about 100,000, about 200,000, about 300,000, about 400,000, about 500,000, about 1,000,000, about 2,000,000, about 3,000,000, about 4,000,000, about 5,000,000, about 10,000,000, about 50,000,000, about 100,000,000, or about 1,000,000,000.

A test for assessing the accuracy of system ratings can be measured by inter-rater reliability. Inter-rater reliability can describe the level of agreement between raters or judges based on scores given by the raters and judges. A measure of inter-rater reliability can be useful in assessing whether a given variable is an appropriate measurement for a test. In some embodiments of the invention, judges are used to score health care professionals and their adherence to care protocols with and without assistance of the system. Inter-rater reliability can be applied in this context to provide some certainty that the judges who are scoring the users are scoring the subjects appropriately, as many of the measures can be subjective in nature. Inter-rater reliability can be measured by determining the percentage of answers or scores that are common between the raters. If the measurements are continuous, then a correlation between the responses can be established.

The correlation among ratings in an inter-rater reliability test can be described by the Pearson's correlation coefficient (r). The Pearson's correlation coefficient can describe the linear relationship between two results as a score between −1 and +1. The correlation coefficient for a sample, r, can be calculated using the following formula:

$$r = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}} ,$$

where n is the sample size; i=1, 2, . . . , n; X and Y are the variables, and X̅ and Y̅ are the means for the variables. The square of the Pearson's correlation coefficient, r², is known as the coefficient of determination, and can be used to explain the fraction of variance in Y as a function of X in a simple linear regression.

The value of the correlation coefficient for inter-rater reliability can be, for example, about −1, about −0.95, about −0.9, about −0.85, about −0.8, about −0.75, about −0.7, about −0.65, about −0.6, about −0.55, about −0.5, about −0.45, about −0.4, about −0.35, about −0.3, about −0.25, about −0.2, about −0.15, about −0.1, about −0.05, about 0, about 0.05, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, or about 1.

A Student's t-test is a statistical test that can be employed by a system of the invention to determine the differences in the means of the results of two populations of subjects using the system. In the present system, the t-test can be used to measure the adherence to care protocols between the control and intervention groups. The test statistic (t) for the t-test of an independent, two sample study is calculated using the formula below:

$$t = \frac{( {\overline{X}}_{T} - {\overline{X}}_{C} )}{\sqrt{\frac{{var}_{T}}{{n}_{T}} + \frac{{var}_{c}}{{n}_{c}}}}$$

where X̅ is the sample mean, n is the sample size and

$$var = \frac{\sum {( X - \overline{X} )}^{2}}{n - 1}$$

The degrees of freedom for such a test are 2n−2. Once the test statistic has been calculated, a p-value can be determined using a table of values following the Student's t-distribution. If the calculated p-value is below the value determined at the defined α level, and the corresponding degrees of freedom, then the result is considered significant. The result can be significant at a p-value of less than 0.05 if, for example, the a level was defined as 0.05.

The α level for the Student's t-test can be set at, for example, about 0.5, about 0.45, about 0.4, about 0.35, about 0.3, about 0.25, about 0.2, about 0.15, about 0.1, about 0.05, about 0.04, about 0.03, about 0.02, about 0.01, about 0.009, about 0.008, about 0.007, about 0.006, about 0.005, about 0.004, about 0.003, about 0.002, about 0.001, about 0.0001, about 0.00001, about 0.000001, about 0.0000001, or about 0.00000001.

A Wilcoxon rank sum (Mann-Whitney test) can be used by a system of the invention to determine the differences in means between two populations of subjects using the system. In the present system, the Wilcoxon rank sum can be used to measure the adherence to care protocols between the control and intervention groups. For larger samples, ranks, numbered from 1 onwards, can be assigned to the observed values. The test statistic (U) for the Wilcoxon rank sum of an independent, two sample study is calculated using the formula below:

$${U}_{1} = {n}_{1} {n}_{2} + \frac{{n}_{1} ( {n}_{1} + 1 )}{2} - {R}_{1}$$

where n is the sample size and R₁ is the sum of the ranks in sample 1. Once the test statistic has been calculated, a p-value can be determined using a table of critical values for the Mann-Whitney test. If the calculated p-value is below the value determined at the defined α level, and the corresponding degrees of freedom, then the result is considered significant. The result can be significant at a p-value of less than 0.05 if, for example, the a level was defined as 0.05.

The α level for the Wilcoxon rank sum can be set at, for example, about 0.5, about 0.45, about 0.4, about 0.35, about 0.3, about 0.25, about 0.2, about 0.15, about 0.1, about 0.05, about 0.04, about 0.03, about 0.02, about 0.01, about 0.009, about 0.008, about 0.007, about 0.006, about 0.005, about 0.004, about 0.003, about 0.002, about 0.001, about 0.0001, about 0.00001, about 0.000001, about 0.0000001, or about 0.00000001.

Any tool, interface, engine, application, program, service, command, or other executable item can be provided as a module encoded on a computer-readable medium in computer executable code. In some embodiments, the invention provides a computer-readable medium encoded therein computer-executable code that encodes a method for performing any action described herein, wherein the method comprises providing a system comprising any number of modules described herein, each module performing any function described herein to provide a result, such as an output, to a user.

### EXAMPLES

### Example 1

### Application of the System to Neonatal Care as an Example of the System of the Disclosure as a Point of Use Training Tool for Clinicians

To test the effectiveness of the system, 65 health care professionals with current neonatal resuscitation program (NRP) certification, including physicians, nurse practitioners, and obstetrical/neonatal nurses, were recruited for a study to simulate application of the system for a neonate. The subjects were recruited via e-mail from three different neonatal intensive care units. Eighteen residents, 1 fellow, 7 attending physicians, 2 respiratory therapists, and 37 nurses were the final sample. Thirty subjects were randomized to the control group and 35 subjects to the intervention group. In the control group, the participants were expected to rely on their memory and prior medical knowledge to treat simulated neonates. In the intervention group, the participants were assisted using the present invention. A prospective, randomized, controlled study was conducted wherein the subjects participated in three standardized simulated neonatal resuscitation scenarios, designated as scenarios A, B, and C, and presented in random order. The measured outcomes included percent adherence to the NRP algorithm in providing positive pressure ventilation (PPV), initiation of chest compressions (CC), and frequency of fraction of inspired oxygen (FiO₂) adjustments, as clinically indicated.

The study was conducted at a training and research center specially-equipped to simulate a delivery and resuscitation room realistically with microphones, cameras, and a computerized neonatal patient simulator. The simulation specialists were skilled in creating the complex visual, auditory, and tactile cues necessary to produce a high degree of realism functioning as health care professionals and family members and engendering behavior in subjects consistent with real life. The study room was separated from a control room by a one-way minor to allow for observation by the control room personnel and study directors.

A neonatal patient simulator was used for the study. The heart rate (HR), respiratory rate (RR), tone, color and breath sounds were controlled remotely and could be assessed by the participants by auscultation of the thorax, observation of chest movement, and palpation of the umbilical cord. Vital signs that are typically available in a delivery room, for example, HR and hemoglobin oxygen saturation via pulse oximetry (SpO₂), were set via a computerized control interface and displayed on the bedside monitor integrated with the neonatal patient simulator.

During all scenarios, the subjects could obtain HR by assessing the patient, referencing the bedside monitor, or verbally confirming HR with the control room personnel. Subjects in the intervention group could also obtain HR using the present invention. SpO₂ data was not made available in any scenario until one minute after birth to mimic a possible delay in detection in a real clinical environment. Additionally, the SpO₂ determined using the neonatal simulator was not shown on the bedside monitor when the HR was less than 60 beats per minute (BPM).

Prior to beginning the study scenarios, the subjects were provided with a review of common NRP terminology, for example, CPAP versus PPV, and equipment, for example, self-inflating bag and radiant warmer. The subjects were then instructed that scoring would reflect decision-making skills rather than technique. Subjects were familiarized with all elements of the simulated delivery room, including the neonatal patient simulator. All subjects were assigned to be the resuscitation team leader and were instructed to conduct the resuscitation by working with two experienced simulation specialists who assisted with intubation, CC, umbilical venous catheter placement and patient assessment. Additionally, subjects in the intervention group received a brief orientation to the present invention.

All subjects in the control and intervention groups were presented with the same three, 4.5-minute clinical scenarios, in random order. The vital signs of the simulated neonates were pre-determined and pre-programmed into the invention, and did not vary in response to clinical interventions performed by the subjects. Scenario A comprised a 4.5-kilogram neonate with the clinical history listed as: “late dates, scheduled Cesarean section. Prenatal history was significant for mild oligohydramnios and maternal gestational diabetes that was diet-controlled.” The simulated patient's initial HR was 110 BPM. Over the course of the scenario, the simulated patient's HR varied between 70-130 BPM and SpO₂ ranged from 50%-85%. Scenario B involved a 3.5-kilogram neonate with the clinical history of “term gestation neonate born vaginally after prolonged second stage of pitocin-augmented labor for maternal preeclampsia.” The simulated patient's initial HR was 50 BPM. Over the course of the scenario, the simulated patient's HR varied between 40-130 BPM and SpO₂ ranged from 55%-85%. Scenario C consisted of a 2.5-kilogram neonate with the clinical history described as a “28-week gestation, precipitous vaginal delivery.” The simulated neonate's initial HR was 120 BPM. Over the course of the scenario, the simulated patient's HR varied between 30-180 BPM and SpO₂ ranged from 50%-75%. All scenarios were videotaped and the recordings were independently reviewed and scored by two NRP instructors. The scenarios were evaluated for the initiation and cessation of PPV and CC, as well as the frequency of FiO₂ adjustment.

During the video review, the start and stop times for PPV and CC and the timing of FiO₂ adjustment were recorded. The start time for PPV or CC was defined as the time when the subject made a decision by performing the action or verbalizing that the action should be performed. The stop time for PPV or CC was defined as the time when the subject made a decision by discontinuing the action or verbalizing that the action should be stopped. The time at which the FiO₂ adjustment occurred was defined as the time when the percent FiO₂ was addressed or changed. A Wilcoxon rank sum (Mann-Whitney test) was used to compare the adherence of the control and intervention groups to the NRP algorithm.

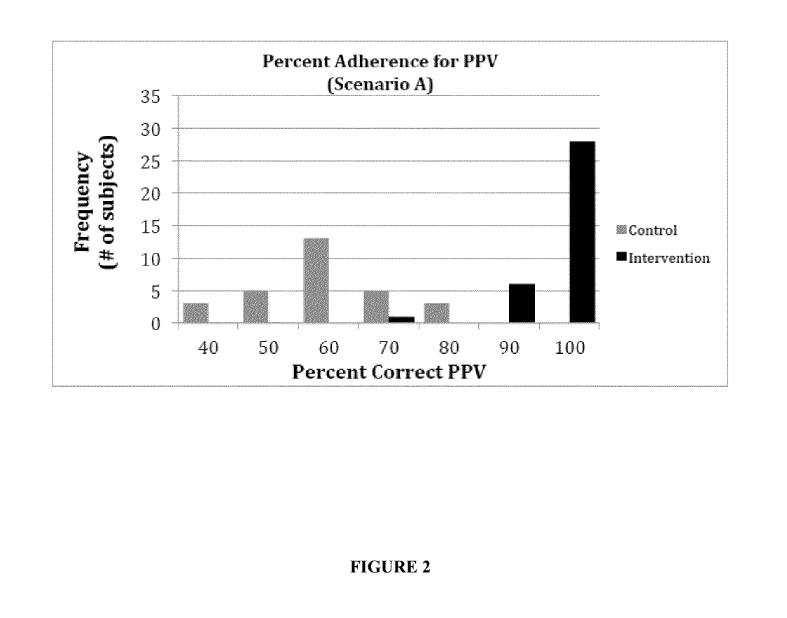

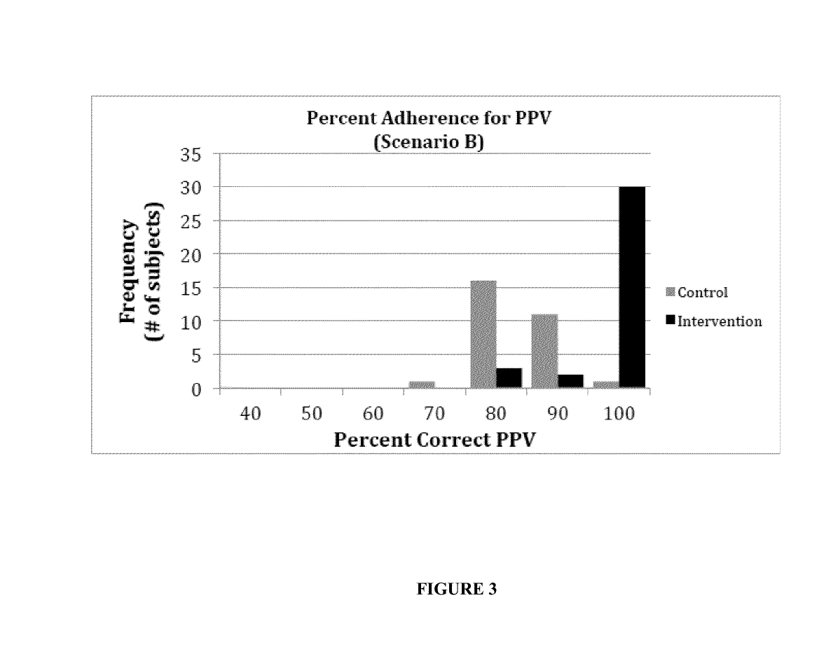

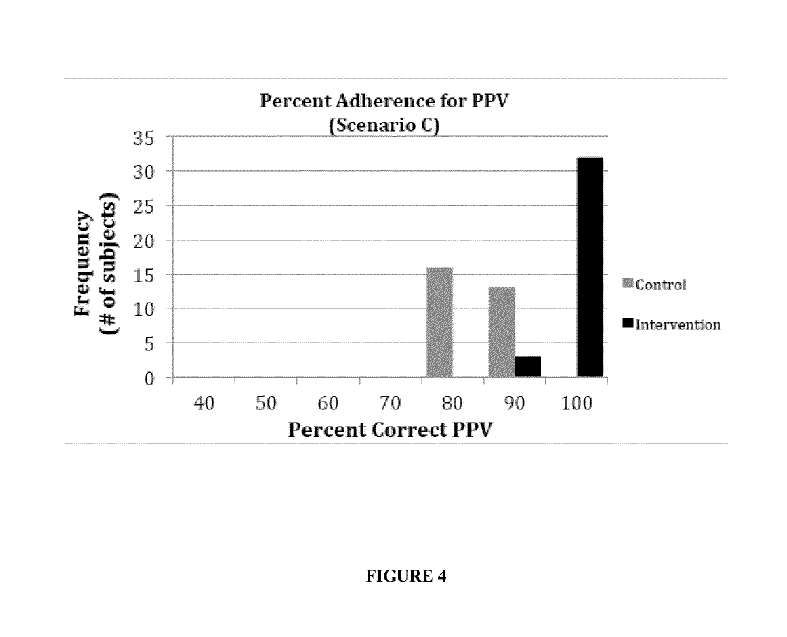

The subjects' decision to perform or not perform PPV and CC was evaluated, rather than the subjects' ability to perform PPV and CC correctly. The number of seconds during the scenario that each subject had correctly decided to perform or not to perform PPV or CC was independently tallied. The highest possible score was 270, based upon the number of seconds in a 4.5-minute scenario. This raw number was converted to the percentage of time the correct decision was made for each intervention. For PPV, average percentage of correct performance ranged from 55-80% in the control group and 94-95% in the intervention group across the three scenarios (p<0.001, FIGS. 2-4).

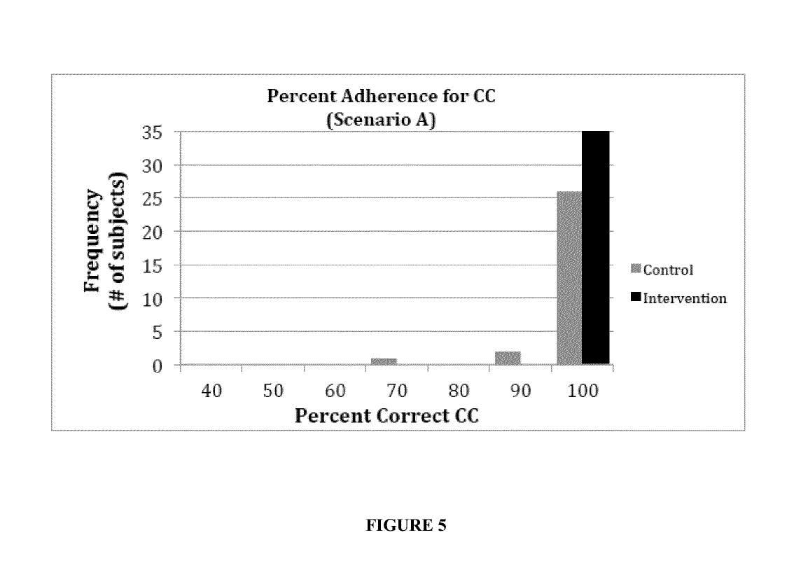

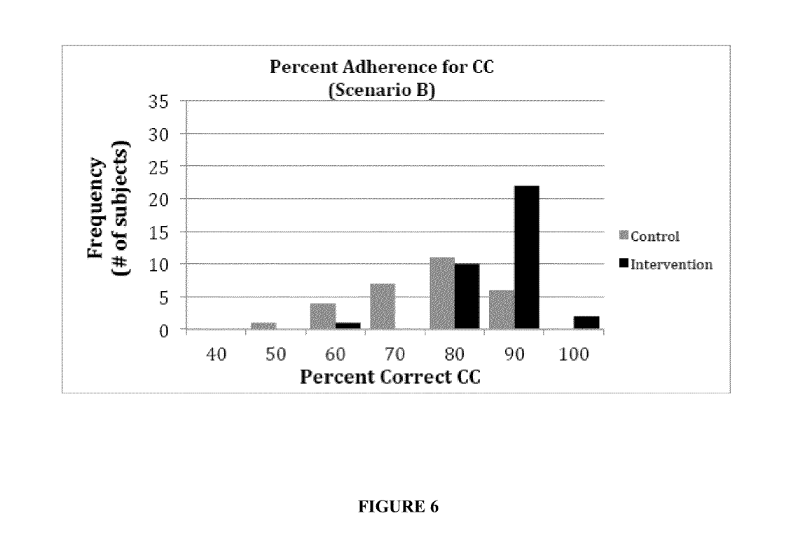

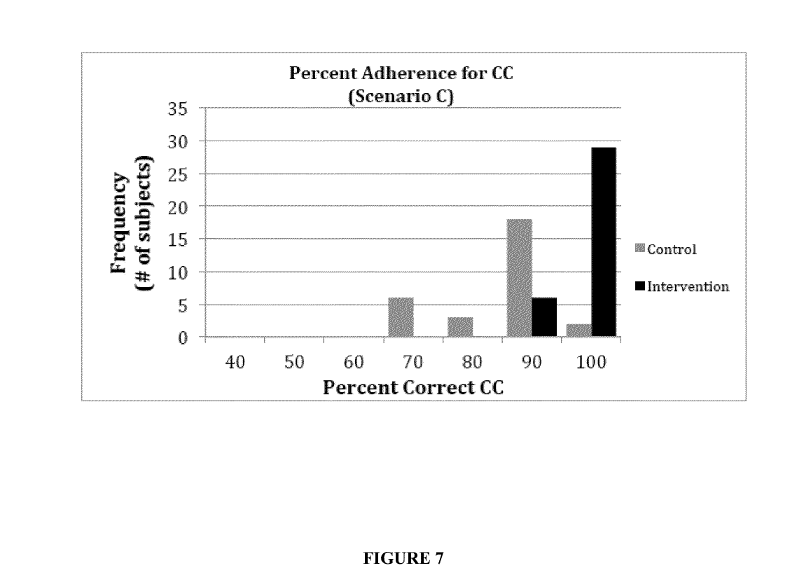

For CC in Scenario B, the average percentage of correct performance was 71% in the control group and 82% in the intervention group (p<0.001, FIG. 6). For CC in Scenario C, the average percentage of correct performance was 81% in the control group and 93% in the intervention group (p<0.001, FIG. 7). In Scenario A, CC were not clinically indicated, but two subjects in the control group made the incorrect decision to perform CC. Therefore, the results between the control and intervention groups for Scenario A were not statistically significant (p<0.082, FIG. 5) because the intervention group performed CC correctly 100% of the time.

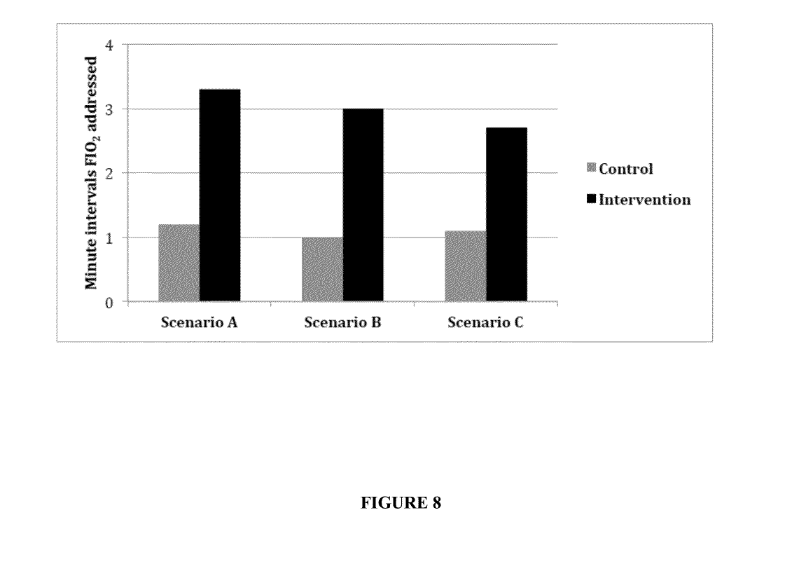

For FiO₂ adjustment, each subject received a score based on whether the FiO₂ was addressed at least once during each minute interval of the four-minute scenario. This interval was derived from the NRP guidelines, which recommend goal SpO₂ ranges for neonates in the first five minutes of life. FiO₂ should have been addressed each minute to achieve these goals; therefore, the total possible score ranged from 0 to 4. Number of minute intervals during which FiO₂ was addressed ranged from 1-1.2 in the control group and 2.7-3.3 in the intervention group (p<0.001, FIG. 8). The inter-rater reliability was assessed and determined that 99% of all time points were recorded within five seconds of one another, indicating strong agreement between the two video reviewers.

Health care professionals exhibited significantly fewer deviations from the NRP algorithm when utilizing a system provided herein compared to those working from memory alone during simulated neonatal resuscitation. Subjects in the intervention group more frequently provided PPV and CC when clinically indicated and avoided procedures that were not mandated by the algorithm. Subjects in the intervention group were also more likely to initiate PPV correctly prior to the start of CC. This observation is significant because initiation of proper ventilation is crucial to neonatal resuscitation, and adequate ventilation can be sufficient to prevent further degradation of cardiac function. Erroneously providing CC when not indicated can cause unnecessary morbidity, for example, rib fractures and pneumothoraces. With respect to FiO₂ adjustment, the results showed that subjects in the intervention group were sensitized to be more aware of the patient's SpO₂ and the need to change the FiO₂ compared to those of the control group. This enhanced awareness can translate into more frequent adjustments and closer conformity of SpO₂ to the clinical standards recommended by the NRP.

Subjects did not serve as their own controls. Based on pilot study observations, subjects who were first assigned to the intervention group demonstrated better adherence to the NRP algorithm in all subsequent control scenarios. This trend was likely due to review of the NRP algorithm during use of the decision support tool of the present invention.

Health care professionals using a decision support tool of the present invention exhibited significantly fewer deviations from the NRP algorithm compared to those working from memory alone during simulated neonatal resuscitation. Performance in a realistic simulation can serve as a surrogate for performance during real clinical events. Therefore, use of a decision support tool during actual neonatal resuscitation can improve human performance in clinical practice by reducing errors.

### Example 2

### User Interfaces for Display in Systems of the Invention

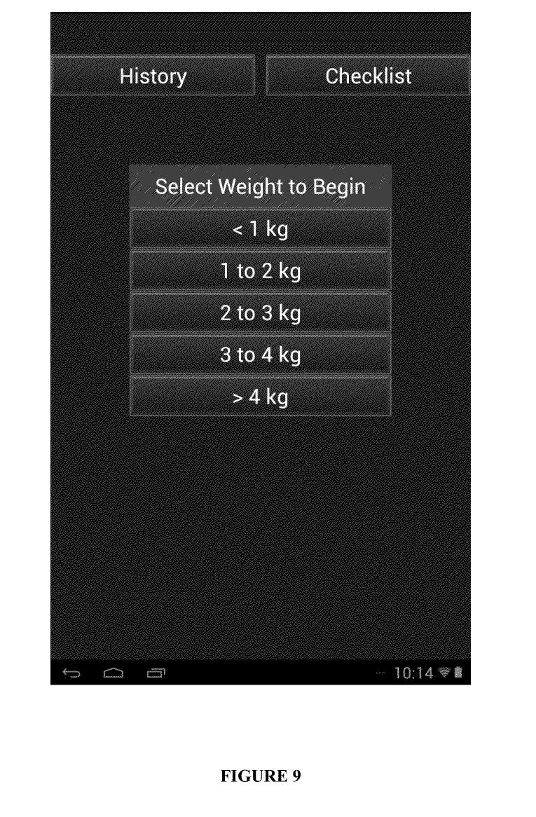

FIG. 9 depicts an illustrative touch screen that is seen by the user upon initialization of the system for neonatal care. When the “history” prompt is touched, the user sees historical data for the subject that includes, for example, maternal, prenatal, and labor history, fetal heart rate monitoring classification, maternal laboratory results, fetal testing results, fetal ultrasounds, intrapartum medications, and perinatal risk calculators. When the “checklist” prompt is touched, the user sees actions that should be taken including, for example, warmer set up, tool audit, postnatal laboratory tests, and procedure timers. The user then begins the active care path by inputting the estimated neonatal weight by selecting from<1 kg, 1 to 2 kg, 2 to 3 kg, 3 to 4 kg, or >4 kg.

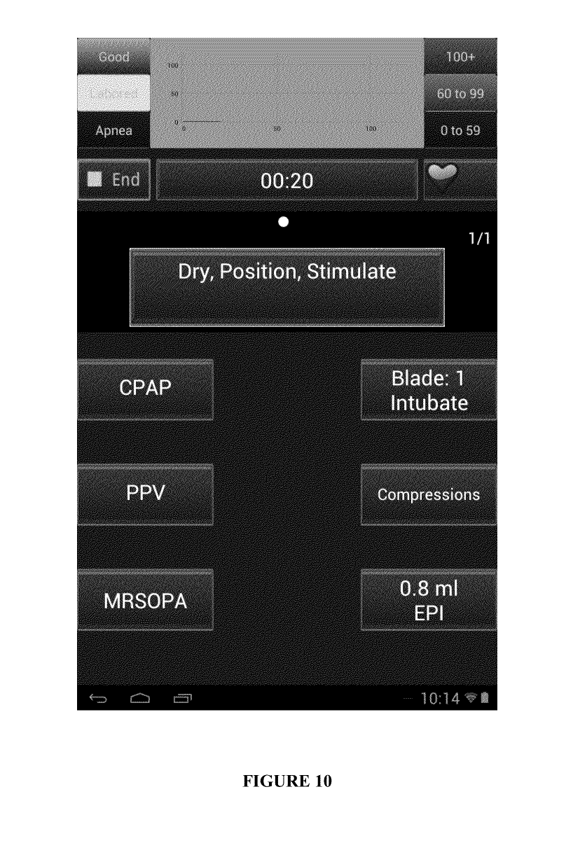

Once a neonatal care path is selected, the user sees an interface as illustrated in FIG. 10. In the upper left corner, the user selects the breathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer. The timer lets the user know for how long the user should auscultate and palpate the neonatal heart rate. After the timer is over, the heart icon prompts the user to select a heart rate category again. The graph at the top of the interface displays heart rate trend data and the timer below the graph is the time elapsed since birth. The middle of the screen is a flexible prompting box including dry, position, stimulate, CPAP, PPV, MRSOPA, intubate, compression, and EPI prompts. The “dry” prompt reminds the user to dry the neonate, the “position” prompt reminds the user to position the neonate's head so as to open the airway, and the “stimulate” prompt reminds the user to stimulate breathing.

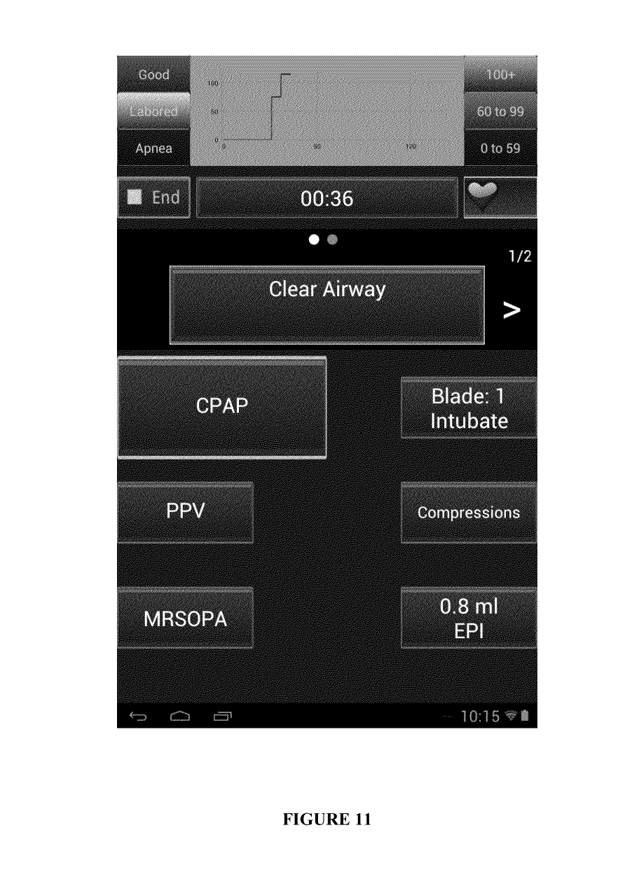

FIG. 11 is an interface seen by a user when a subject is in need of resuscitation care. In the upper left corner, the user selects the breathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer. The graph at the top of the interface displays heart rate trend data and the timer below the graph is the time elapsed since birth. The timer lets the user know for how long the user should auscultate and palpate the neonatal heart rate. After the timer is over, the heart icon prompts the user to select a heart rate category again. The fixed prompts in the bottom half of the interface represent interventions, medicine, and device calculation recommended by a system of the invention for resuscitation care. The prompts that the user selects include clear airway, CPAP, PPV, MRSOPA, intubate, compression, and EPI. The fixed prompts have five categories of activity including quiet, not prompted or active, prompted, not active, prompted and activated, stop prompt, and activated without prompting. The displayed medicine dosages and tool sizes are indexed by databases of the invention and estimated weight input by the user.

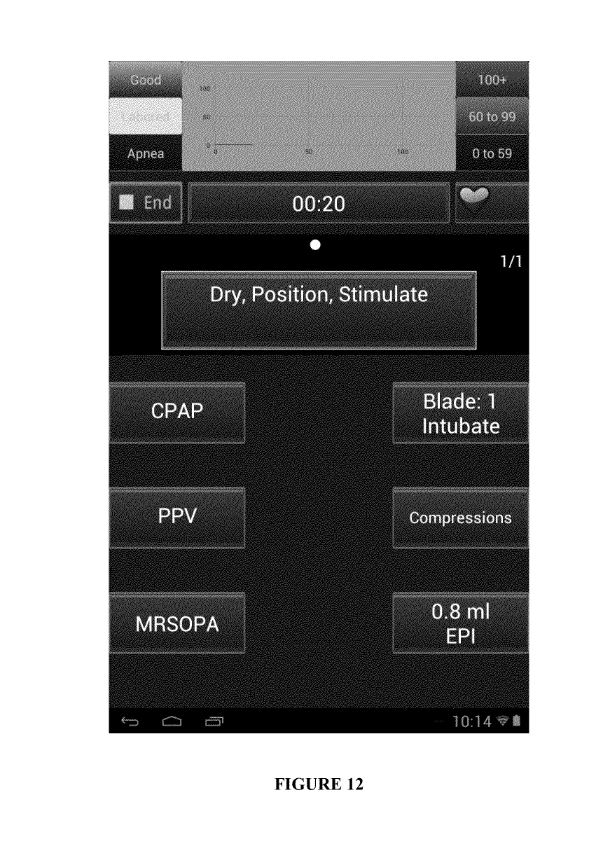

FIG. 12 is an interface seen by a user to monitor the breathing status of a subject. In the upper left corner, the user selects “labored” for the breathing status of the subject. In the upper right corner, the user selects the heart rate of the subject from 100+, 60 to 99, or 0 to 59 beats per minute. The heart icon is the heart rate assessment timer and is pressed by the user to display a timer. The graph at the top of the interface displays heart rate trend data and timer below the graph is the time elapsed since birth. The timer lets the user know for how long the user should auscultate and palpate the neonatal heart rate. After the timer is over, the heart icon prompts the user to select a heart rate category again. The middle of the screen is a flexible prompting box including dry, position, stimulate, CPAP, PPV, MRSOPA, intubate, compression, and EPI prompts.

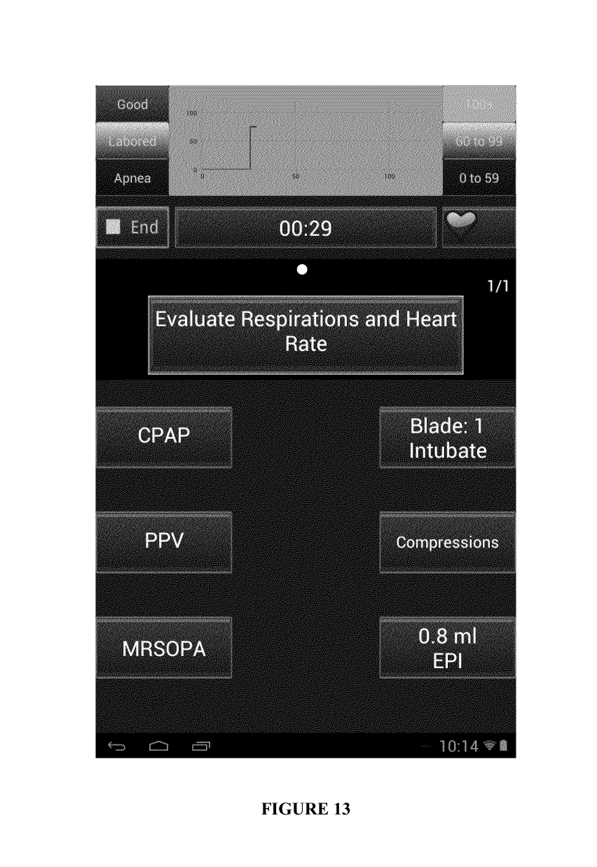

In FIG. 13, the user selects “labored” for the breathing selection and 100+ beats per minute for the heart rate selection. The heart icon is the heart rate assessment timer and is pressed by the user to display a timer. The graph at the top of the interface displays heart rate trend data and timer below the graph is the time elapsed since birth. The timer lets the user know for how long the user should auscultate and palpate the neonatal heart rate. After the timer is over, the heart icon prompts the user to select a heart rate category again. The middle of the screen prompts the user to evaluate respirations and heart rate. The rest of the screen is a flexible prompting box including CPAP, PPV, MRSOPA, intubate, compression, and EPI prompts.

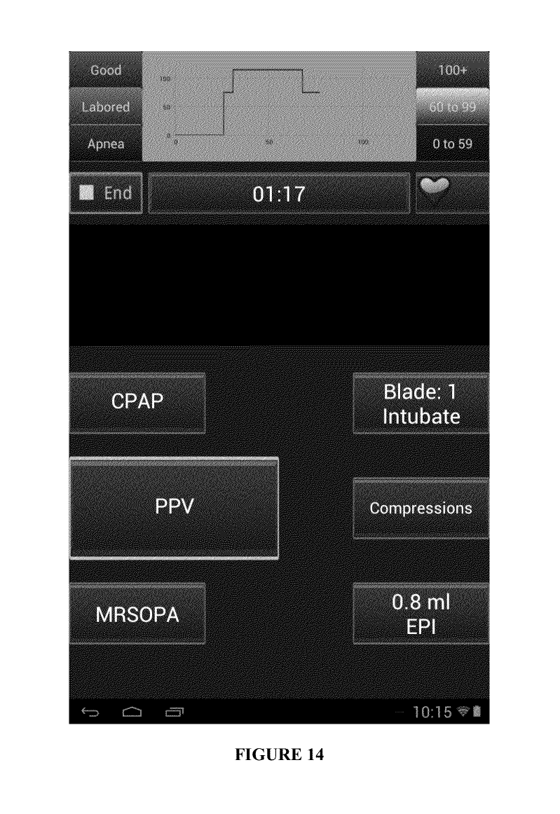

FIG. 14 is a user interface that suggests that the user begin positive pressure ventilation as depicted by the enlarged and highlighted prompt box for PPV. The graph displays serial heart rate inputs over time with elapsed time from birth underneath. In the upper left corner, the user selects the breathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer.

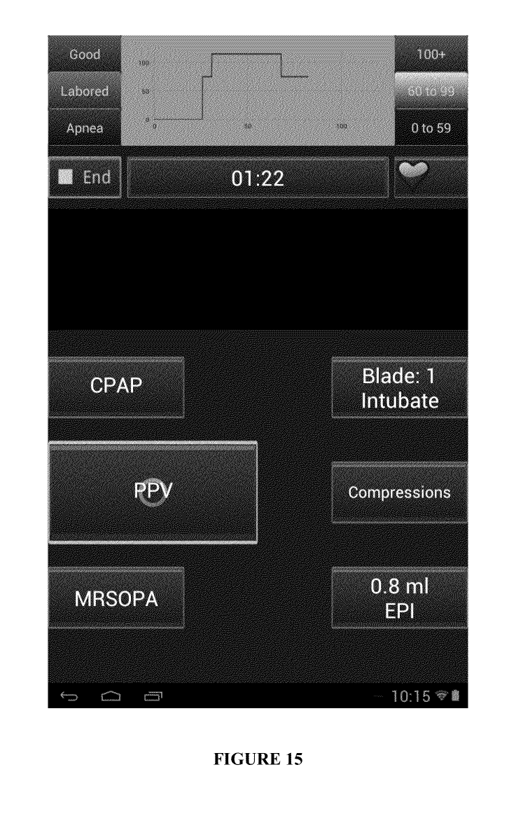

FIG. 15 is a user interface that depicts a prompted and active PPV prompt. The activation of the prompt is signified by the circle icon in the center of the PPV box. A visual and audio pacing metronome is displayed to help the user administer ventilations at a standard of care rate and duration. In the upper left corner, the user selects the breathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer.

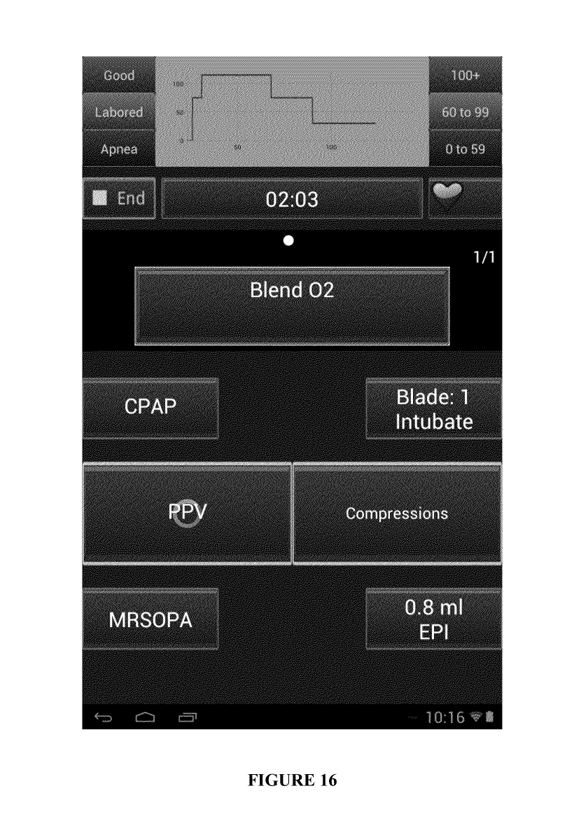

FIG. 16 illustrates a user interface in which the system prompts compressions after activation of the PPV prompt. The prompting of compressions is indicated by the enlarged and highlighted box. The center prompts instructs the user to blend O₂ for administration. In the upper left corner, the user selects the bereathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer.

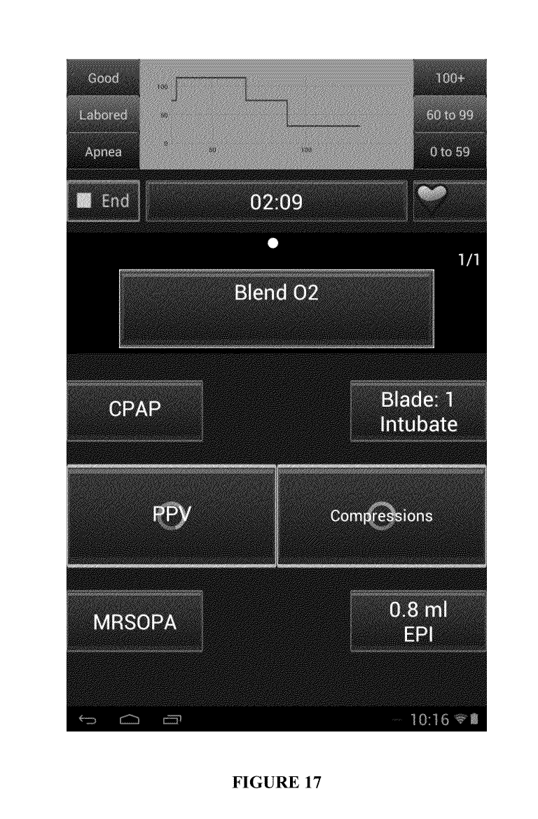

FIG. 17 illustrates a user interface in which the system activates compressions after prompting of the compressions prompt. The activation of compressions is indicated by the circle in the center of the compression box. The center prompts instructs the user to blend O₂ for administration. The PPV metronome is interpolated with the chest compression metronome to assist in pacing and coordination of administration of PPV with chest compressions. The PPV and chest compressions are administered at different rates and durations. In the upper left corner, the user selects the breathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer.

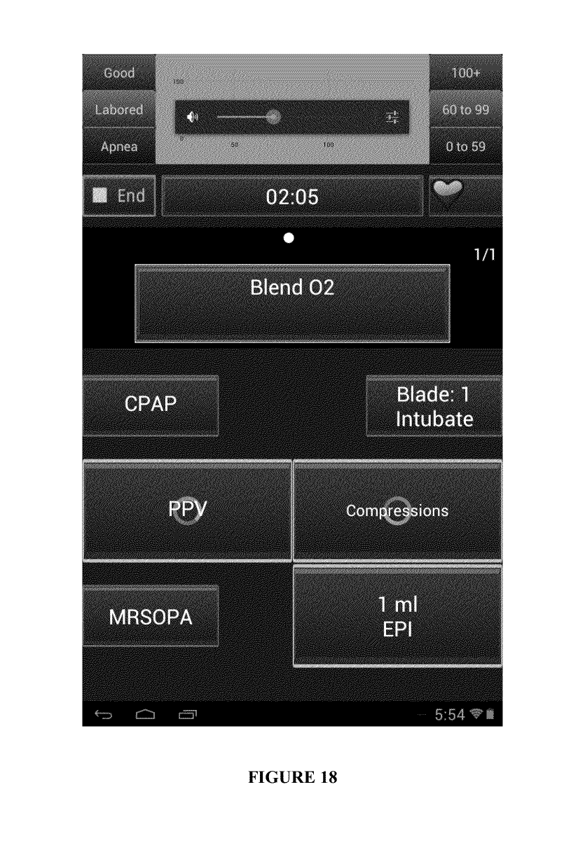

FIG. 18 illustrates a user interface in which the system has active PPV and compression prompts, and epinephrine administration is prompted. The prompting of epinephrine is indicated by the enlarged and highlighted box labeled “1 mL EPI.” In the upper left corner, the user selects the breathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer.

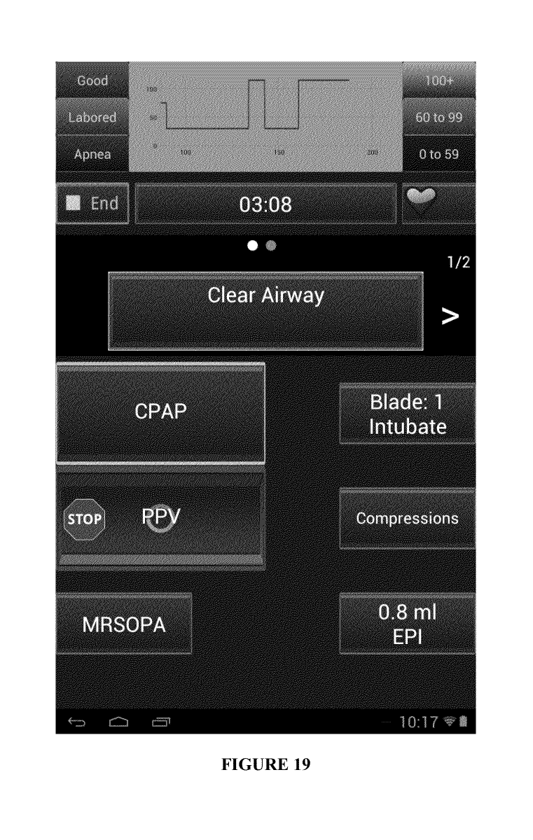

FIG. 19 depicts a user interface in which the user is suggested to stop PPV, as indicated by the “stop” icon in the PPV box, and begin CPAP as indicated by the enlarged and highlighted CPAP prompt box. The center icon instructs the user to clear the airway of the subject. In the upper left corner, the user selects the breathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer. The center icon instructs the user to clear the airway of the subject.

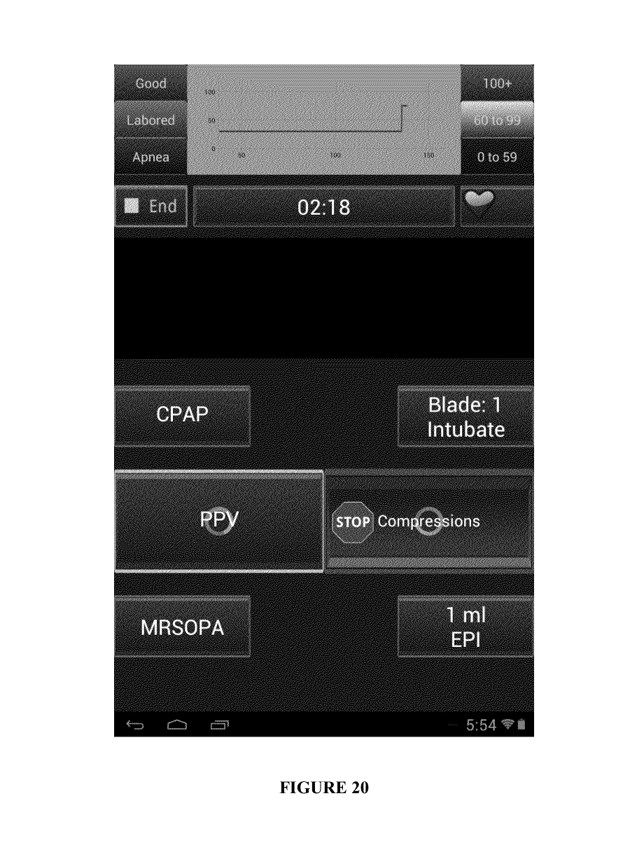

FIG. 20 depicts a user interface in the user is suggested to stop chest compressions, as indicated by the “stop” icon in the compressions box, and begin PPV as indicated by the enlarged and highlighted CPAP prompt box. When the stop compressions box is acknowledged, the box shrinks, highlight is removed, the stop sign and circle icon disappear, and the compression metronome is stopped. In the upper left corner, the user selects the breathing status of the subject from “good,” “labored,” or “apnea.” In the upper right corner, the user selects the heart rate of the subject from 100+, 60 to 99, or 0 to 59 beats per minute. The heart icon is the heart rate assessment timer and is pressed by the user to display a timer.

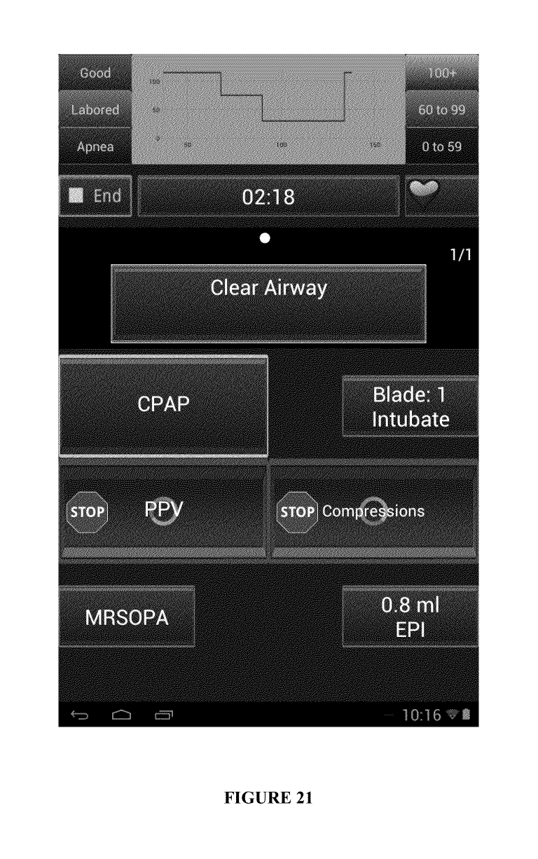

FIG. 21 depicts a user interface in the user is suggested to stop PPV, as indicated by the “stop” icon in the PPV box, stop compressions, as indicated by the “stop” icon in the compressions box, and prompted to begin CPAP as indicated by the enlarged and highlighted box. In this interface, the user selects a heart rate of>100 beats per minute. The user acknowledges all three prompts with the PPV and compression prompts going to the quiescent phase by shrinking the box, removing highlighting, and removing circle and stop icons. In the upper left corner, the user selects the breathing status of the subject from “good,” “labored,” or “apnea.” The heart icon is the heart rate assessment timer and is pressed by the user to display a timer. The center icon instructs the user to clear the airway of the subject.

### Example 3

### Computer Architectures

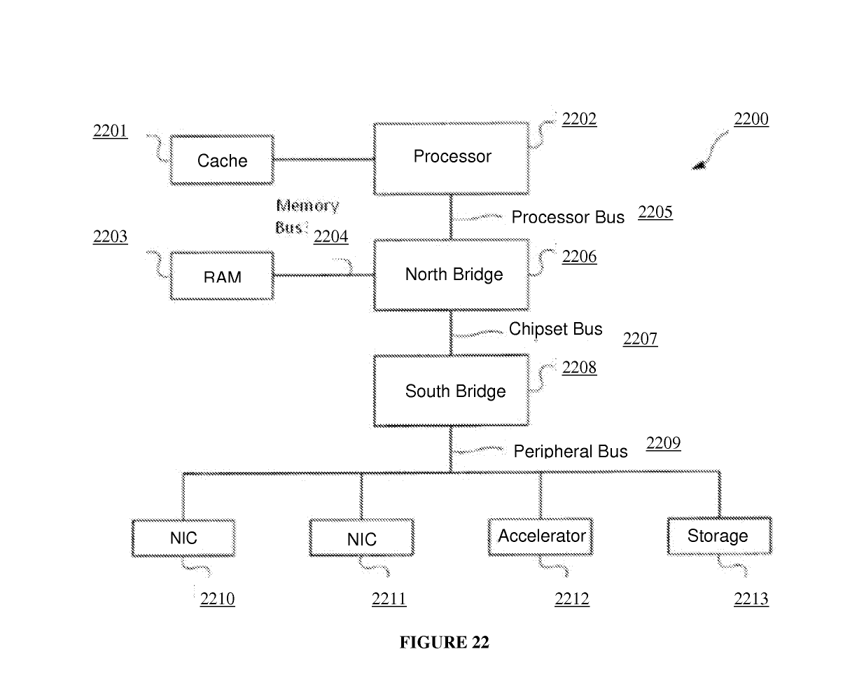

Various computer architectures are suitable for use with the invention. FIG. 22 is a block diagram illustrating a first example architecture of a computer system 2200 that can be used in connection with example embodiments of the present invention. As depicted in FIG. 22, the example computer system can include a processor 2202 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

### Data Acquisition, Processing and Storage.

As illustrated in FIG. 22, a high speed cache 2201 can be connected to, or incorporated in, the processor 2202 to provide a high speed memory for instructions or data that have been recently, or are frequently, used by processor 2202. The processor 2202 is connected to a north bridge 2206 by a processor bus 2205. The north bridge 2206 is connected to random access memory (RAM) 2203 by a memory bus 2204 and manages access to the RAM 2203 by the processor 2202. The north bridge 2206 is also connected to a south bridge 2208 by a chipset bus 2207. The south bridge 2208 is, in turn, connected to a peripheral bus 2209. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 2209. In some architectures, the functionality of the north bridge can be incorporated into the processor instead of using a separate north bridge chip.

In some embodiments, system 2200 can include an accelerator card 2212 attached to the peripheral bus 2209. The accelerator can include field programmable gate arrays (FPGAs) or other hardware for accelerating certain processing.

### Software Interface(s).

Software and data are stored in external storage 2213 and can be loaded into RAM 2203 and/or cache 2201 for use by the processor. The system 2200 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 2200 also includes network interface cards (NICs) 2210 and 2211 connected to the peripheral bus for providing network interfaces to external storage, such as Network Attached Storage (NAS) and other computer systems that can be used for distributed parallel processing.

### Computer Systems.

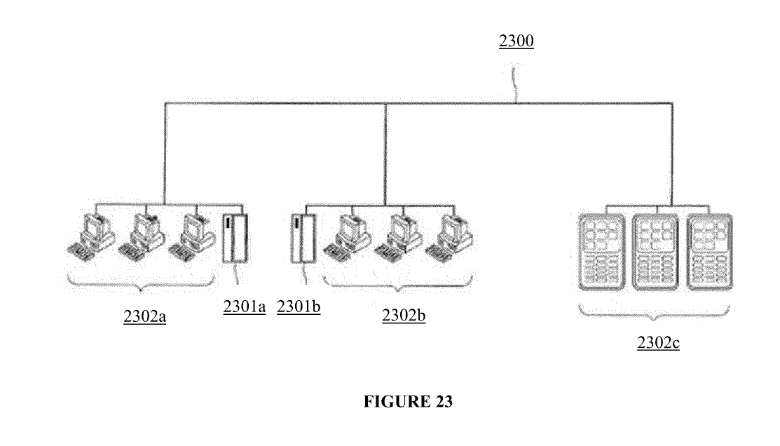

FIG. 23 is a diagram showing a network 2300 with a plurality of computer systems 2302a, and 2302b, a plurality of cell phones and personal data assistants 2302c, and Network Attached Storage (NAS) 2301a, and 2301b. In some embodiments, systems 2302a, 2302b, and 2302c can manage data storage and optimize data access for data stored in Network Attached Storage (NAS) 2301a and 2302b. A mathematical model can be used for the data and be evaluated using distributed parallel processing across computer systems 2302a, and 2302b, and cell phone and personal data assistant systems 2302c. Computer systems 2302a, and 2302b, and cell phone and personal data assistant systems 2302c can also provide parallel processing for adaptive data restructuring of the data stored in Network Attached Storage (NAS) 2301a and 2301b. FIG. 23 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

### Virtual Systems.

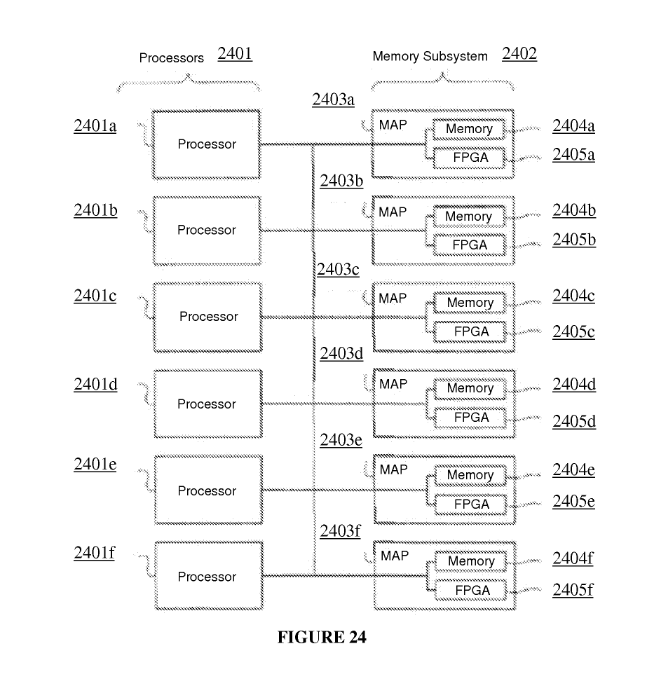

FIG. 24 is a block diagram of a multiprocessor computer system using a shared virtual address memory space. The system includes a plurality of processors 2401a-f that can access a shared memory subsystem 2402. The system incorporates a plurality of programmable hardware memory algorithm processors (MAPs) 2403a-f in the memory subsystem 2402. Each MAP 2403a-f can comprise a memory 2404a-f and one or more field programmable gate arrays (FPGAs) 2405a-f. The MAP provides a configurable functional unit and particular algorithms or portions of algorithms can be provided to the FPGAs 2405a-f for processing in close coordination with a respective processor. In this example, each MAP is globally accessible by all of the processors for these purposes. In one configuration, each MAP can use Direct Memory Access (DMA) to access an associated memory 2404a-f, allowing it to execute tasks independently of, and asynchronously from, the respective microprocessor 2401a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 24, system on chips (SOCs), application specific integrated circuits (ASICs), or other processing and logic elements. For example, the Set Processor and Optimizer can be implemented with hardware acceleration through the use of a hardware accelerator card, such as accelerator card 2212 illustrated in FIG. 22.

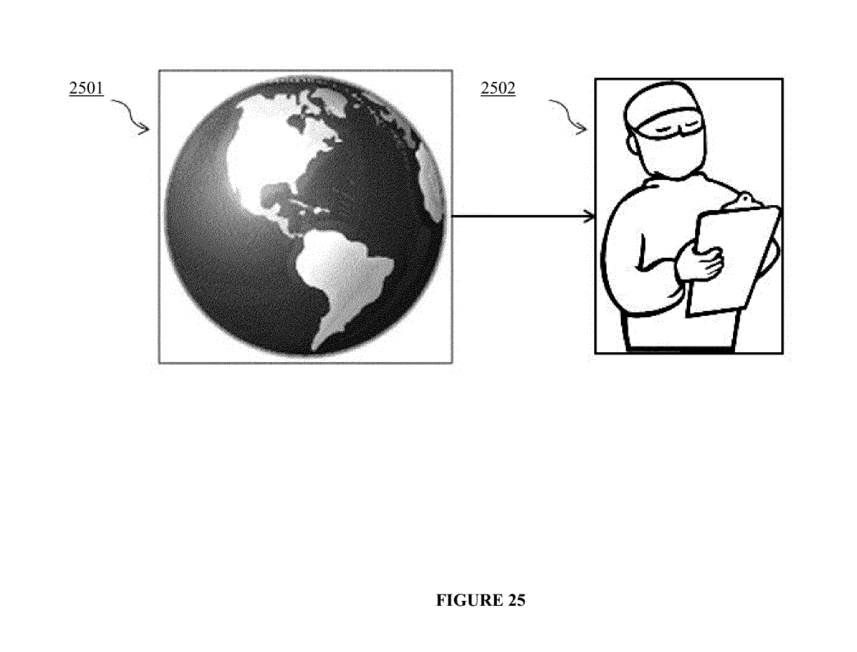

Any embodiment of the invention described herein can be, for example, produced and transmitted by a user within the same geographical location. A product of the invention can be, for example, produced and/or transmitted from a geographic location in one country and a user of the invention can be present in a different country. In some embodiments, the data accessed by a system of the invention is a computer program product that can be transmitted from one of a plurality of geographic locations 2501 to a user 2502 (FIG. 25). Data generated by a computer program product of the invention can be transmitted back and forth among a plurality of geographic locations, for example, by a network, a secure network, an insecure network, an internet, or an intranet. In some embodiments, an ontological hierarchy provided by the invention is encoded on a physical and tangible product.

### Embodiments

Embodiment 1. A method of providing a healthcare protocol, the method comprising: a) receiving by a computer system a parameter of a subject; b) searching by a processor of the computer system based on the parameter of the subject in a database, wherein each entry in the database independently comprises: i) a healthcare protocol; and ii) an indication of a likelihood of obtaining a favorable outcome upon application of the healthcare protocol to the subject as determined by a statistical analysis of the healthcare protocol based on prior clinical use of the healthcare protocol;
c) identifying the healthcare protocol in the database based on the search of the database; and
d) outputting the identified healthcare protocol.

Embodiment 2. The method of embodiment 1, the method further comprising receiving an updated parameter of the subject, and identifying an alternative healthcare protocol based on the updated parameter.

Embodiment 3. The method of any one of embodiments 1-2, wherein the parameter for the subject is received from user input.

Embodiment 4. The method of any one of embodiments 1-3, wherein the parameter for the subject is received from a sensor of a device that monitors the subject.

Embodiment 5. The method of embodiment 4, wherein the sensor of the device that monitors the subject is attached to the subject.

Embodiment 6. The method of embodiment 4, wherein the sensor of the device that monitors the subject is not attached to the subject.

Embodiment 7. The method of any one of embodiments 1-6, wherein the healthcare protocol is an emergency care protocol.

Embodiment 8. The method of any one of embodiments 1-7, wherein the healthcare protocol is an observational care protocol.

Embodiment 9. The method of any one of embodiments 1-8, wherein the healthcare protocol is a routine care protocol.

Embodiment 10. The method of any one of embodiments 1-9, wherein the parameter is a physiological parameter.

Embodiment 11. The method of any one of embodiments 1-10, wherein the parameter is a positional parameter.

Embodiment 12. The method of any one of embodiments 1-11, wherein the parameter is a geographic parameter.

Embodiment 13. The method of any one of embodiments 1-13, wherein the outputting identifies the healthcare protocol most likely to result in a favorable clinical outcome for the subject.

Embodiment 14. A method of accessing a healthcare protocol, the method comprising: a) accessing by a user a computer system, wherein the computer system comprises a database, wherein each entry in the database independently comprises: i) a healthcare protocol; and ii) an indication of a likelihood of obtaining a favorable clinical outcome upon application of the healthcare protocol to a subject as determined by a statistical analysis of the healthcare protocol based on prior clinical use of the healthcare protocol; b) inputting by the user or system a parameter of the subject into the computer system; c) searching the database by a processor of the computer system based on the parameter of the subject; and d) identifying the healthcare protocol in the database based on the search of the database.

Embodiment 15. The method of embodiment 14, the method further comprising inputting by the user or system an updated parameter of the subject, and identifying an alternative healthcare protocol based on the updated parameter.

Embodiment 16. The method of any one of embodiments 14-15, wherein the healthcare protocol is a routine care protocol.

Embodiment 17. The method of any one of embodiments 14-16, wherein the healthcare protocol is an observational care protocol.

Embodiment 18. The method of any one of embodiments 14-17, wherein the healthcare protocol is an emergency care protocol.

Embodiment 19. The method of any one of embodiments 14-18, wherein the identification of the healthcare protocol identifies the healthcare protocol most likely to result in a favorable clinical outcome for the subject.

Embodiment 20. The method of any one of embodiments 14-19, wherein the user performs a diagnostic intervention to the subject based on the identified care protocol.

Embodiment 21. The method of any one of embodiments 14-20, wherein the user performs a therapeutic intervention to the subject based on the identified care protocol.

Embodiment 22. The method of any one of embodiments 14-21, wherein the parameter is a physiological parameter.

Embodiment 23. The method of any one of embodiments 14-22, wherein the parameter is a positional parameter.

Embodiment 24. The method of any one of embodiments 14-23, wherein the parameter is a geographic parameter.

What is claimed is:

1. A method of providing a healthcare protocol, the method comprising:
a) receiving by a computer system a parameter of a subject;
b) searching by a processor of the computer system based on the parameter of the subject in a database, wherein each entry in the database independently comprises:
i) a healthcare protocol; and
ii) an indication of a likelihood of obtaining a favorable outcome upon application of the healthcare protocol to the subject as determined by a statistical analysis of the healthcare protocol based on prior clinical use of the healthcare protocol;
c) identifying the healthcare protocol in the database based on the search of the database; and
d) outputting the identified healthcare protocol.

2. The method of claim 1, the method further comprising receiving an updated parameter of the subject, and identifying an alternative healthcare protocol based on the updated parameter.

3. The method of claim 1, wherein the parameter for the subject is received from user input.

4. The method of claim 1, wherein the parameter for the subject is received from a sensor of a device that monitors the subject.

5. The method of claim 4, wherein the sensor of the device that monitors the subject is attached to the subject.

6. The method of claim 4, wherein the sensor of the device that monitors the subject is not attached to the subject.

7. The method of claim 1, wherein the healthcare protocol is an emergency care protocol.

8. The method of claim 1, wherein the healthcare protocol is an observational care protocol.

9. The method of claim 1, wherein the healthcare protocol is a routine care protocol.

10. The method of claim 1, wherein the parameter is a physiological parameter.

11. The method of claim 1, wherein the parameter is a positional parameter.

12. The method of claim 1, wherein the parameter is a geographic parameter.

13. The method of claim 1, wherein the outputting identifies the healthcare protocol most likely to result in a favorable clinical outcome for the subject.

14. A method of accessing a healthcare protocol, the method comprising:
a) accessing by a user a computer system, wherein the computer system comprises a database, wherein each entry in the database independently comprises:
i) a healthcare protocol; and
ii) an indication of a likelihood of obtaining a favorable clinical outcome upon application of the healthcare protocol to a subject as determined by a statistical analysis of the healthcare protocol based on prior clinical use of the healthcare protocol;
b) inputting by the user or system a parameter of the subject into the computer system;
c) searching the database by a processor of the computer system based on the parameter of the subject; and
d) identifying the healthcare protocol in the database based on the search of the database.

15. The method of claim 14, the method further comprising inputting by the user or system an updated parameter of the subject, and identifying an alternative healthcare protocol based on the updated parameter.

16. The method of claim 14, wherein the healthcare protocol is a routine care protocol.

17. The method of claim 14, wherein the healthcare protocol is an observational care protocol.

18. The method of claim 14, wherein the healthcare protocol is an emergency care protocol.

19. The method of claim 14, wherein the identification of the healthcare protocol identifies the healthcare protocol most likely to result in a favorable clinical outcome for the subject.

20. The method of claim 14, wherein the user performs a diagnostic intervention to the subject based on the identified care protocol.

21. The method of claim 14, wherein the user performs a therapeutic intervention to the subject based on the identified care protocol.

22. The method of claim 14, wherein the parameter is a physiological parameter.

23. The method of claim 14, wherein the parameter is a positional parameter.

24. The method of claim 14, wherein the parameter is a geographic parameter.
